(19) United States
(12) Patent Application Publication
(10) Pub. No.: US 2011/0163944 A1
(43) Pub. Date: Jul. 7, 2011

(54) INTUITIVE, GESTURE-BASED COMMUNICATIONS WITH PHYSICS METAPHORS

(75) Inventors: Brett Bilbrey, Sunnyvale, CA (US); Nicholas V. King, San Jose, CA (US); Todd Benjamin, Saratoga, CA (US)

(73) Assignee: APPLE INC., Cupertino, CA (US)

(21) Appl. No.: 12/652,719

(22) Filed: Jan. 5, 2010

(51) Int. Cl. G09G 5/00; G06F 3/048

(52) U.S. Cl. 345/156; 715/863

(57) ABSTRACT

A user can make an intuitive, physical gesture with a first device, which can be detected by one or more onboard motion sensors. The detected motion triggers an animation having a “physics metaphor,” where the object appears to react to forces in a real world, physical environment. The first device detects the presence of a second device and a communication link is established allowing a transfer of data represented by the object to the second device. During the transfer, the first device can animate the object to simulate the object leaving the first device and the second device can animate the object to simulate the object entering the second device. In some implementations, in response to an intuitive, gesture made on a touch sensitive surface of a first device or by physically moving the device, an object can be transferred or broadcast to other devices or a network resource based on a direction, velocity or speed of the gesture.

### TECHNICAL FIELD

This disclosure relates generally to communications, and more particularly, to data transfer between devices.

### BACKGROUND

When an individual performs an action in a real world, physical environment, the individual experiences various physical phenomenon that indicates that the task is being performed or has been completed. For example, if an individual pours objects from a first container into a second container, the individual can observe the objects reacting to the forces of friction and gravity. If the objects having different shapes and masses, then the individual would observe different reactions to the forces.

Conventional personal computers include operating systems that often provide a virtual “desktop” metaphor where users can manipulate and organize various objects. This metaphor is easily understood by users because it is intuitive, and like the “pouring” act described above, relates to their real world, physical environment. Modern computing devices, such as smart phones, often provide a large variety of applications. Some of these applications, however, provide interfaces that lack an equivalent of the “desktop” metaphor and as a result are more difficult to comprehend by the average user.

### SUMMARY

A user can make an intuitive, physical gesture with a first device, which can be detected by one or more onboard motion sensors. The detected motion triggers an animation having a “physics metaphor,” where the object appears to react to forces in a real world, physical environment. The first device detects the presence of a second device and a communication link is established allowing a transfer of data represented by the object to the second device. During the transfer, the first device can animate the object to simulate the object leaving the first device and the second device can animate the object to simulate the object entering the second device. In some implementations, in response to an intuitive, gesture made on a touch sensitive surface of a first device or by physically moving the device, an object can be transferred or broadcast to other devices or a network resource based on a direction, velocity or speed of the gesture.

Particular embodiments of the subject matter described in this specification can be implemented to realize one or more of the following advantages. Users can transfer files and other data between devices using intuitive gestures combined with animation based on physics metaphors. Users can transfer files to a network using intuitive physical gestures. Users can broadcast files and other data to other devices using intuitive interface or physical gestures.

The details of one or more implementations of user interfaces for mobile device communication are set forth in the accompanying drawings and the description below. Other features, aspects, and advantages of proactive security for mobile devices will become apparent from the description, the drawings, and the claims.

### BRIEF DESCRIPTION OF THE DRAWINGS

FIGS. 1A-1C illustrate an exemplary intuitive, gesture-based data transfer between two devices using animation based on a physics metaphor.

FIG. 2 illustrates initiation of an exemplary communications session with a device in response to an interface gesture.

FIG. 3 illustrates initiation of an exemplary data broadcast from a device to multiple devices in response to a physical gesture.

FIG. 4 illustrates an exemplary data transfer between two devices in response to intuitive, physical gestures.

FIG. 5 illustrates an exemplary physical gesture for initiating a communications session with a network.

FIG. 6 is a flow diagram of an exemplary process for using intuitive, physical gestures to initiate a communications session between devices.

FIG. 7 is a flow diagram of an exemplary process for using intuitive, interface gestures to initiate a communications session between devices.

FIG. 8 is a block diagram of exemplary network operating environment for a device for implementing the features and operations described in reference to FIGS. 1-7.

FIG. 9 is a block diagram illustrating an exemplary device architecture of a device implementing the features and operations described in reference to FIGS. 1-7.

Like reference symbols in the various drawings indicate like elements.

### DETAILED DESCRIPTION

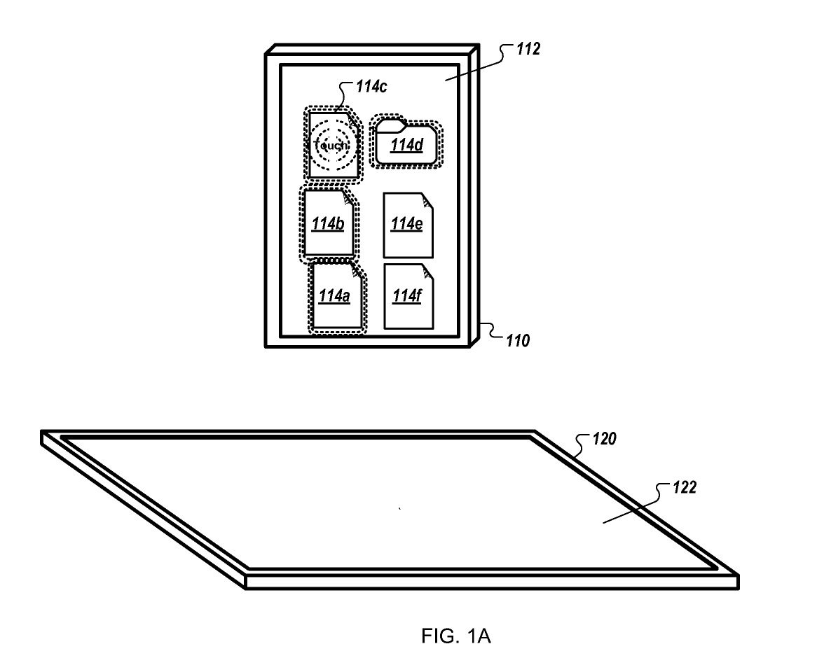

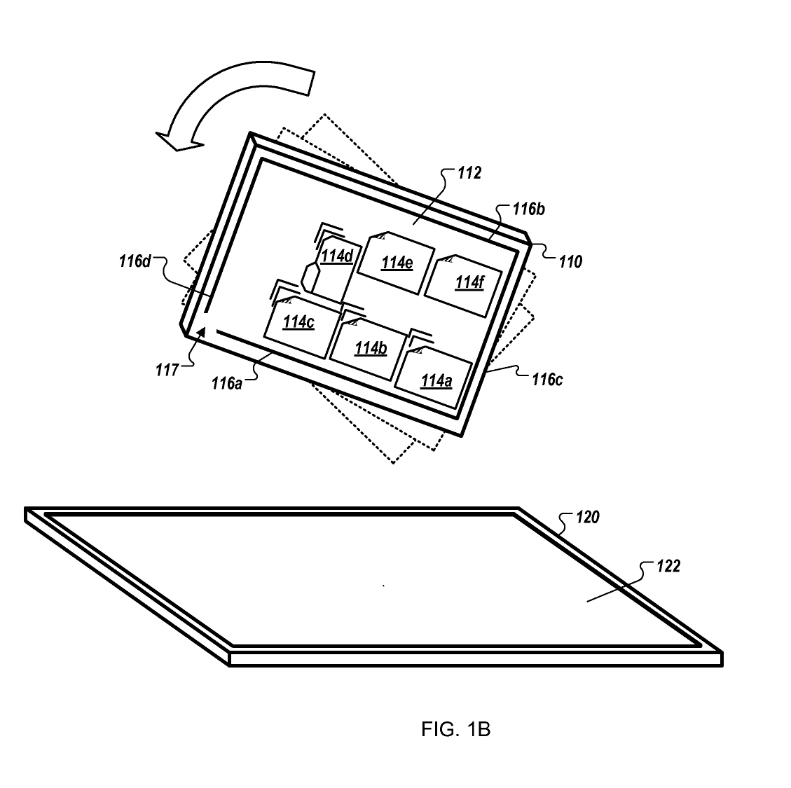

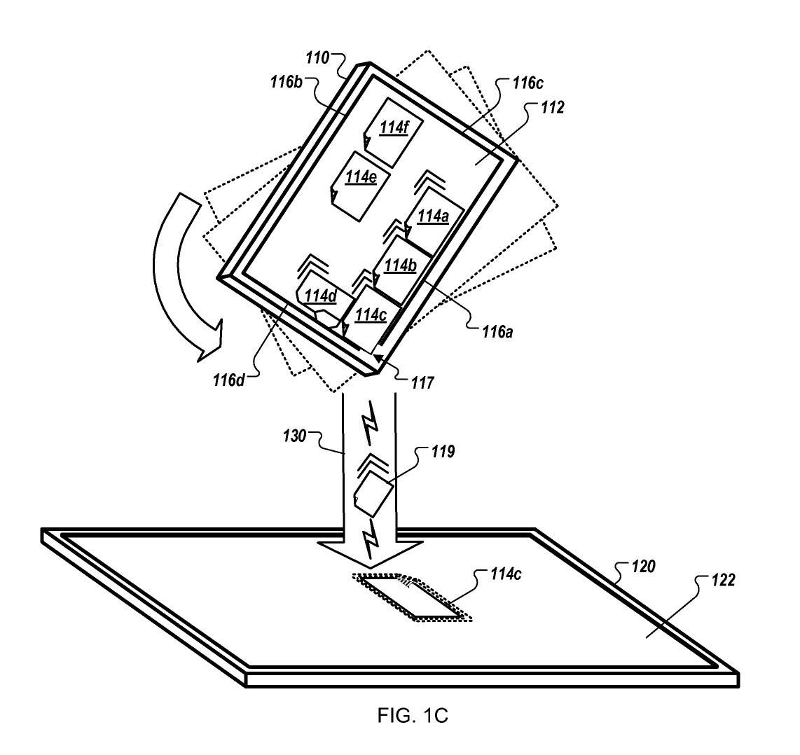

FIGS. 1A-1C illustrate an exemplary intuitive, gesture-based communication between two devices using animation based on a physics metaphor. Referring to FIG. 1A, devices 110, 120 are shown in close proximity and having a relative orientation. Devices 110, 120 can be any electronic device capable of displaying information and communicating with other devices, including but not limited to: personal computers, handheld devices, electronic tablets, Personal Digital Assistants (PDAs), cellular telephones, network appliances, cameras, smart phones, network base stations, media players, navigation devices, email devices, game consoles, automotive informatics systems (e.g., a dashboard, entertainment system) and any combination of these devices. In the example shown, device 110 is a handheld device and device 120 is an electronic tablet 120. Devices 110, 120 can include respective interfaces 112, 122 for displaying graphical objects, such as icons representing files, folders or other content. In the example shown, interfaces 112, 122 can be touch sensitive surfaces that are responsive to touch and touch gesture input.

Interface 112 is shown displaying a collection of graphical objects 114a-114f (e.g., file icons) representing files stored on device 110. In some implementations, the user can select one or more files for transfer to one or more devices by placing the files into a transfer state. In the example shown, the user has selected four files for transfer by touching their respective objects 114a-114d for a predetermined amount of time and/or using a predetermined amount of pressure during the touch. The user can also select a group of files for transfer by drawing a circle around the icons with a finger or stylus, then using a touch, gesture or other input to select the group of files for transfer. In some implementations, the user can drag and drop individual files onto a container object (e.g., a “suitcase” icon) displayed on interface 112, and then use a touch, gesture or other input to select the container of files for transfer. Other means for selecting individual files or groups of files for transfer are also possible, including but not limited to selecting files through menus or other conventional user interface elements.

In some implementations, the selected objects 114a-114d can be detached from interface 112 and allowed to freely “float” on interface 112. The boundaries of interface 112 can be configured to behave like “bumpers” during device motion; such that floating objects 114a-114d bounce off the boundaries of interface 112 while objects 114e and 114f remain fixed to interface 112.

FIG. 1B illustrates device 110 in motion relative to device 120. In some implementations, device 110 can be equipped with one or more motion sensors (not illustrated) that detect when device 110 is moved. Motion sensors can include but are not limited to accelerometers, gyroscopes and magnetometers. In the example shown, the user is holding device 110 directly over interface 122, and has made a physical gesture with device 110. A physical gesture can be any gesture that moves a device or changes the orientation of a device. Here, the user has rotated device 110 above interface 122 in a manner similar to tipping a glass of water. This angular motion can be detected by one or more onboard motion sensors.

As shown in FIG. 1B, detached objects 114a-114d can be animated to simulate the effect of gravity by “sliding” toward the lowermost portion of interface 112 as device 110 is rotated. The animation of the objects creates the appearance that the objects have mass and are reacting to forces of a real world, physical environment. Selected objects 114a-114d, being detached from interface 112, can slide until they touch boundaries 116a or 116c of interface 112. Objects 114e and 114f, being fixed to interface 112, can remain in their original positions on interface 112.

FIG. 1C illustrates devices 110, 120 executing an intuitive, gesture-based file transfer. The user has rotated device 110 relative to interface 112 such that boundary 116d of interface 112 is substantially parallel with interface 122. In response to the new orientation of device 110, a graphics engine onboard device 110 animates selected objects 114a-114d to simulate the movement of objects 114a-114d under the force of gravity and friction. For example, selected objects 114a-114d can be animated to slide toward an intersecting corner of boundaries 116a, 116d of interface 112. Device 110 can interpret the rotation of device 110 (e.g., a “pouring” action) as an indication of the user's intent to transfer the files represented by selected objects 114a-114d.

Upon determining that the user of device 110 intends to transfer the files represented by selected objects 114a-114d, device 110 determines if device 120 is present and available to receive the files. In some implementations, device 110 can use onboard short-range communication technology, such as Bluetooth or Radio Frequency Identification (RFID) to detect the presence of device 120. In the example shown, device 110 has files in a transfer state and detects the presence of device 122. If device 120 is within a predetermined range of device 110, then device 110 can attempt to establish a communications link 130 with device 120. After a link is established and authenticated, device 110 can request that device 120 accept a file transfer. Upon an acknowledgement of acceptance from device 120, device 110 can transfer the files represented by objects 114a-114d to device 120 using known communication protocols.

As the data transfers from device 110 to device 120, icons representative of the transferred data can appear on interface 122 of device 120. For example, icon 114c can appear on interface 122 and be animated by a graphics engine on device 120 to change in size or appearance (e.g., grow, fill, materialize) as the data represented by object 114c is received by device 120. As the files represented by the selected objects 114a-114d are transferred, device 120 can animate the objects 114a-114d on interface 122 so as to appear to react to gravity, friction or drag, momentums, torques, accelerations, centripetal forces or any other force found in a real-world, physical environment. For example, transferred files can appear to “drop” onto device 120 at a point directly below device 110 and then spread out onto interface 122 to simulate sand or liquid being poured onto a surface having friction or a viscous drag. The rate at which each object moves on interface 122 can be based on the size or “mass” of the file represented by the object. Larger files that have more “mass” can have their object animated to move slower in interface 122, and small files that have less “mass” can have their object animated to move faster in interface 122.

In some implementations, the object 114c can be detached from interface 122 so that it appears to “float” on interface 122. The user can accept the data represented by icon 114c by providing an interface or physical gesture of device 120 or by other input means. Upon detection of the input, object 114c can be fixed to the interface 122 to visually indicate to the user the acceptance of the data.

The order of data transfer can be determined by the arrangement of objects 114a-114d in interface 112. For example, object 114c, which is closest to a virtual opening 117 in interface 112 can have its corresponding data transferred first because of its close proximity to virtual opening 117. Objects corresponding to larger files can be animated to move slowly to virtual opening 117 and smaller icons can be animated to move more quickly to virtual opening 117, thus enabling a smaller file to be transferred rather than being bottlenecked by a larger file that can take a long time to transfer.

In some implementations, data transfer can be represented by animating objects 114a-114d to simulate a variety of real-world physics. For example, as file 119 represented by object 114c is being transferred, object 114c can be animated on interface 112 to appear distorted around virtual opening 117 to simulate water going down a drain, sand flowing through an hourglass, or a genie being pulled into a bottle (a.k.a. “the genie effect”). In other examples, the animation can simulate object 114c dissolving like a tablet in water or dematerializing. Other animations are possible to convey to the user that data are being emptied from device 110 onto interface 122. In some implementations, data transfer can be represented or accompanied by audible feedback, such as the sound of liquid pouring, a tablet fizzing, gas through a valve, a sci-fi teleporter, or other sound that audibly represent the transfer of a material from one point to another.

The speed of animation or the pitch of sounds associated with data transfer can be determined from the speed of the data transfer. For example, data transfers using a high bandwidth communications link 130 can be animated as “pouring” out of device 110 more quickly than a data transfer occurring over a lower bandwidth connection. In some implementations, the speed of data transfer can be at least partly determined by the orientation of device 110. In some implementations, the data transfer rate, and the speed of associated animations, can change based on the orientation or distance of device 110 relative to interface 122. For example, if device 110 is orientated as shown in FIG. 1B, the data transfer rate over communication link 130 can be slower than the data transfer rate if the device 100 were orientated as shown in FIG. 1C. In this example, if device is orientated to a substantially upright position (e.g., an orientation opposite to the orientation shown in FIG. 1C) the data transfer will stop.

In the example of FIGS. 1A-1C, selected objects 114a-114d are represented as substantially solid objects, but other representations of the data corresponding to the icons can also be used. For example, in FIG. 1A as the user selects objects 114a-114d, objects 114a-114d can be animated to “melt” into a simulated liquid that collects at boundary 116c of interface 112. Multiple selected icons can then be represented at stratified layers of liquid that can be “poured” out of device 110. In some examples, the volume of a given strata can be indicative of the amount of data it represents. In some examples, a liquefaction and stratification metaphor can be used to determine the order in which data can be transferred. For example, the first file selected can remain as the bottommost strata as device 110 is rotated, such that the first selected file “flows” into the bottommost position of interface 122 in FIG. 1C to become the first file to flow out of device 110. In some examples, as data represented by a strata is transferred, the thickness of the strata on interface 112 can shrink to represent a shrinking amount of data that remains to be transferred.

### Example Gesture-Based Peer Communication Session

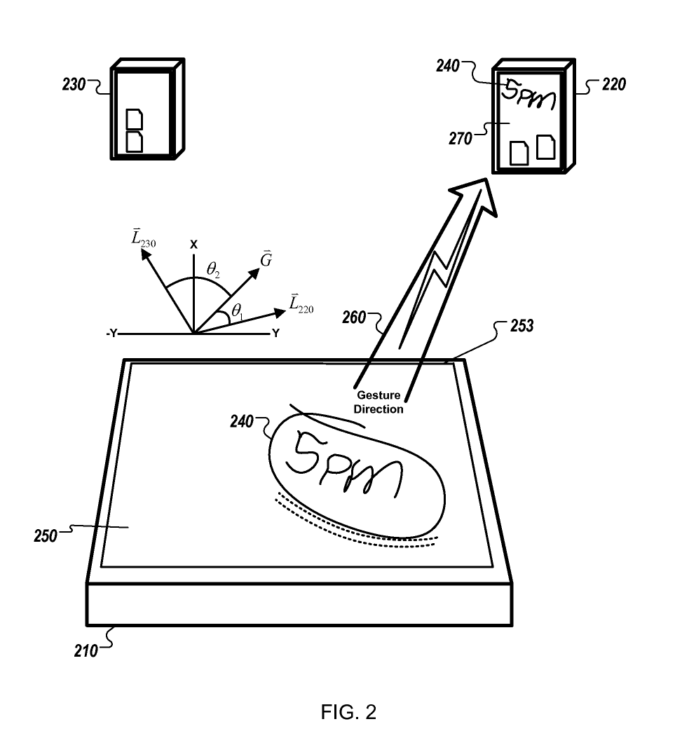

FIG. 2 illustrates initiation of a communications session with a device in response to an interface gesture. Devices 210, 220, 230 can be proximate each other, such as in the same room. Each of devices 210, 230, 230 can be a device, for example, like devices 110 or 120 described above with reference to FIGS. 1A-1C. Devices 210, 220, 230 can be equipped with short-range communication systems (e.g., Bluetooth) which allows each device to scan the room and sense the presence of other devices. Each of the devices can include motion sensors, which allow the devices to maintain a local reference coordinate frame. Each of the devices can also include a positioning system (e.g., a GPS receiver).

In the example shown, the user has drawn a graphical object 240 (e.g., a note) on interface 250 of device 210. The user can input a request to transmit data (e.g., copy data) represented by graphical object 240 to device 220 using touch gesture input to interface 250 (hereinafter also referred to as an “interface gesture”). For example, the user can touch graphical object 240 to select it, and then make a “swipe” or “flick” gesture on interface 250 with one or more fingers in the direction of device 220. Device 210 senses the interface gesture input interacting with graphical object 240 and interprets the gesture as a request to transmit data represented by graphical object 240 to another device.

Before receiving the data transfer request, device 210 can scan the room for the presence of other devices. In this example, devices 220 and 230 are detected. If communication has not been established, device 210 can establish communication with devices 220, 230. In the simplest case, the user of device 210 can manually select one or more devices for data transfer from a list of devices that were detected in the scan (e.g., devices 220, 230). Upon receiving the “swipe” or “flick” gesture requesting data transfer, the data can be transferred to the selected device(s).

In some implementations, device 210 can request position data from devices 220 and 230. For example, in response to the request, devices 220, 230 can send their position vectors in an inertial reference coordinate frame shared by devices 210, 220, 230. For example, devices 220, 230 can send their respective position vectors in the well-known Earth Centered Earth Fixed (ECEF) Cartesian coordinate frame. The position vectors can be obtained from positioning systems onboard devices 220, 230. Using the position vectors and inertial measurements from its own onboard motion sensors, device 210 can compute line of sight (LOS) vectors from device 210 to each target device 220, 230 in ECEF coordinates. The LOS vectors can then be transformed 230 into a display coordinate frame for device 210 using coordinate transformations. For example, device 210 can perform the following coordinate transformations for each LOS vector:

$$\begin{matrix}{\vec{L}}_{ECEF} = {\vec{R}}_{T\_ECEF} - {\vec{R}}_{S\_ECEF} & [ 1 ] \\ {\vec{L}}_{Display} = {T}_{Device}^{Display} {T}_{ECEF}^{Device} {\vec{L}}_{ECEF} . & [ 2 ]\end{matrix}$$

In equation \vec{L}_{ECEF} is the LOS vector from device 210 to device 220 or 230 in ECEF coordinates, and \vec{R}_{S}_{_{—}}_{ECEF}, \vec{R}_{T}_{_{—}}_{ECEF} are the position vectors of device 210 and device 220 or 230, respectively, in ECEF coordinates. In equation [2], \vec{L}_{Display} is the LOS vector from device 210 to device 220 or 230 in display coordinates of device 210,

$${T}_{Device}^{Display}$$

is a transformation matrix from device coordinates of device 210 to display coordinates of device 210,

$${T}_{ECEF}^{Device}$$

is a transformation matrix from ECEF coordinates to device coordinates of device 210. In this example, display coordinates of device 210 is a two dimensional Cartesian coordinate frame where the display of device 210 is defined in FIG. 2 as an x-y plane. The LOS vectors \vec{L}₂₂₀, \vec{L}₂₃₀ of devices 220, 230, respectively, are shown in the x-y plane. Additionally, a vector \vec{G}, representing the direction of the interface gesture made towards device 220 in display coordinates is shown in the x-y plane. The vector \vec{G} can be determined in the x-y plane by an onboard touch model based on raw touch sensor data (e.g., capacitive touch data). To determine the target device (in this example device 220), a dot product can be taken between the \vec{G} vector and each of the LOS vectors \vec{L}₂₂₀, \vec{L}₂₃₀ in the x-y plane. The LOS vector that provides the smallest angle θ with the \vec{G} vector (in this case θ₁) can determine the device to receive the data transfer, which is given by

$$cos θ = \frac{{G}_{x} {L}_{x} + {G}_{y} {L}_{y}}{\vert \vec{G} ‖ \vec{L} \vert} . \qquad [ 3 ]$$

The above technique can be used when position errors are small and there is sufficient angular separation between the communicating devices to ensure an accurate computation of θ. Other techniques for determining the target device can also be used.

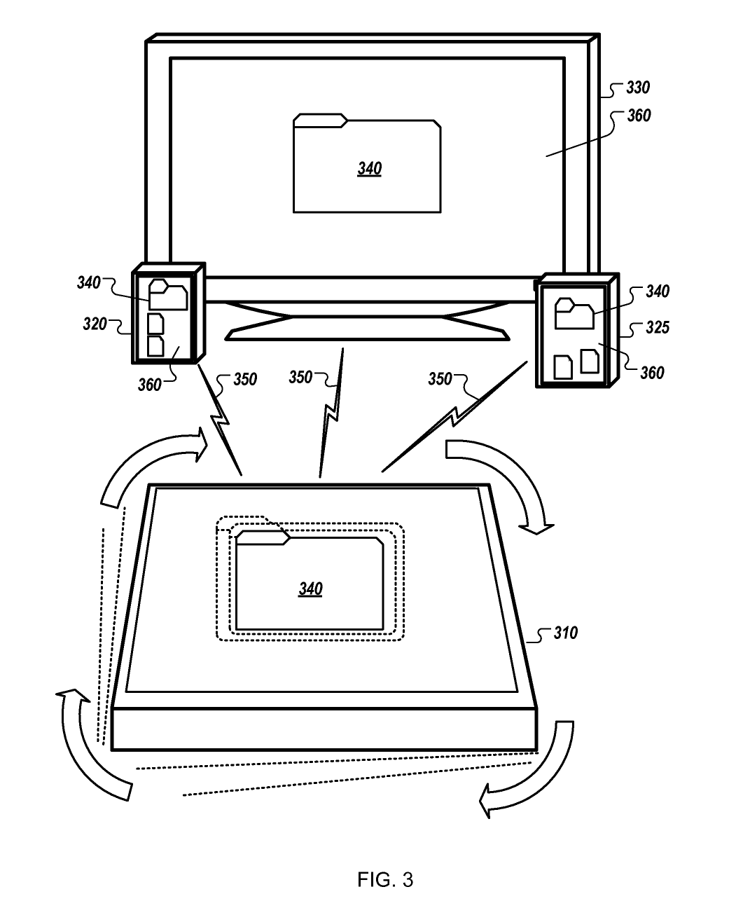

In some implementations, either the user can physically point device 210 at device 220 or device 230 to indicate which device will receive the data transfer. In this case, the LOS vectors can be transformed into device coordinates (without transforming into display coordinates) and equation [3] can be applied by replacing the gesture vector \vec{G} with the device axis that is pointing in the direction of the target device, which in this example is the x-axis shown in FIG. 2. The LOS vector that provides the smallest angle θ with the \vec{x} vector can determine the device to receive the data transfer. Accordingly, a user can use equations [1] through [3] to indicate a target device for data transfer using either an interface gesture in the direction of the desired target device 220, 230 or a physical gesture by physically pointing device 210 at the desired target device 220, 230. In some implementations, multiple target devices can be selected for a broadcast style data transfer using equations [1] through [3] as described with reference to FIG. 3.

In some implementations, graphical object 240 can be animated in response to the gesture to simulate a physics metaphor. For example, graphical object 240 can be animated to simulate the effects of momentum, friction, viscosity, or other aspects of Newtonian mechanics, such that graphical object 240 can continue to move along its trajectory beyond where the gesture started. Simulated friction or viscosity can slow the movement of graphical object 240 as it travels along its trajectory.

In some implementations, the edges of interface 250 may partly resist the motion of graphical object 240 when the two come into contact. For example, the user may have to flick graphical object 240 with a velocity sufficient to overcome a simulated repelling force at edge 253 of interface 250. Some examples of repelling forces include but are not limited to gravity and friction provided by a speed bump or wall of a bubble, where an object either overcomes the repelling force by having sufficient speed to rollover the bump or sufficient speed to break through the bubble wall or has insufficient speed and rolls or bounces back. A gesture imparting sufficient velocity or speed to graphical object 240 can indicate an intent to perform data transfer to another device. A gesture imparting insufficient velocity can result in graphical object 240 rebounding off the edge of interface 250 with no transfer of data. In some examples, this behavior can help device 210 distinguish the difference between gestures intended to reposition graphical object 240 within interface 250 and gestures intended to communicate the data corresponding to graphical object 240 to another device. The speed of the gestures can determine the speed of the graphical object 240. Faster gestures result in higher velocities than slower gestures.

In some implementations, the target devices can initiate an animation that simulates the receipt of data using a physics metaphor. For Example, when device 220 starts to receive data from device 210, device 220 can display animated graphical objects on interface 270 representing data entering device 220. The graphical objects can be detached from interface 270 so that the objects “float.” The user can provide an interface gesture or physical gesture to indicate acceptance of the data. Upon the user's acceptance of the data through a gesture or by other means, the floating objects can become fixed to the interface 270 to visually indicate acceptance of the data to the user.

### Example Gesture-Based Broadcast

FIG. 3 illustrates initiation of a data broadcast from a device to multiple devices in response to a physical gesture. Devices 310, 320, 325, 330 are located in proximity to each other. Devices 310, 320, 325, 330 can be, for example, devices similar to devices 110 or 120 of FIGS. 1A-1C. Device 330 can be a computer enabled display device, such as an electronic tablet, computer monitor, projection screen, electronic whiteboard, teleconferencing screen, television, or other type of device that can display information.

In the example shown, the user has selected graphical object 340 (a file icon) to indicate an intention to perform a data transfer action. Device 310 is also shown in a rotational or sweeping motion due to a user performing a clockwise (or counterclockwise) rotational or sweeping gesture that emulates a toss of a Frisbee®. Motion sensors onboard device 310 senses this physical gesture and interprets it to indicate the user's intent to broadcast data represented by graphical object 340 to devices 320, 320, 325, 330.

If communication has not already been established, device 310 establishes communications link 350 (e.g., a bidirectional Bluetooth link) with devices 320, 325, 330 and transmits data corresponding to graphical object 340 to devices 320, 325, 330. Upon receipt of the transmitted data, devices 320, 325, 330 can display graphical object 340 on their respective displays 360. The graphical object can be detached on the interface or otherwise modified to indicate that the data has not been accepted by the user of the device. The user of devices 320, 325, 330 can provide gesture input or other input means to accept the data. Upon acceptance by the user, icon 340 can be fixed to the interface or otherwise modified to indicate that the data has been accepted onto the device.

### Example Gesture-Based Communication Session

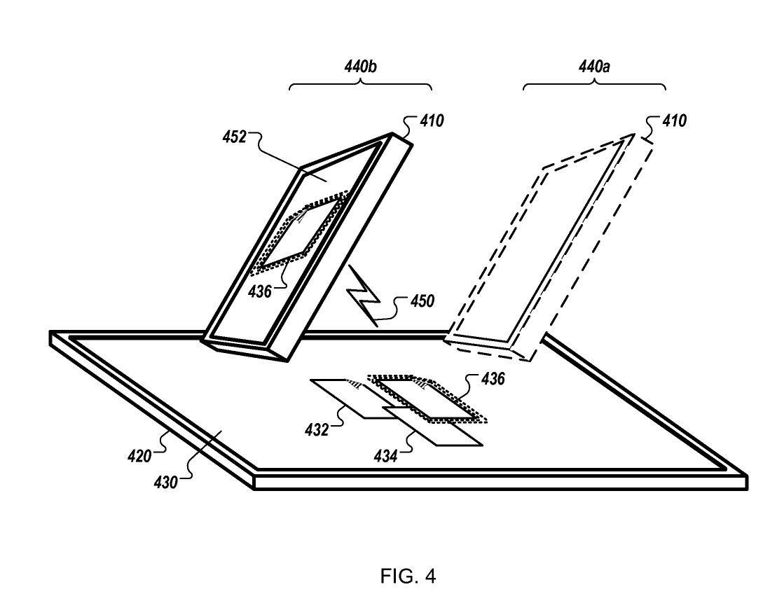

FIG. 4 illustrates a data transfer between two devices in response to intuitive, physical gestures. For illustrative purposes, device 410 can be a handheld personal digital assistant and device 420 can be an electronic tablet. Other devices are also possible.

Device 420 can include display 430 that can display graphical objects 432, 434, and 436 (e.g., file icons) representing electronic files or other electronic data stored in device 420. The user has selected object 436 to indicate an intent to perform one or more actions upon the data corresponding to icon 436. In the example shown, the user intends to request that data corresponding to icon 436 be transferred from device 420 to device 410. The user indicates an intent to transfer data by placing device 410 in position and orientation 440a relative to device 420, and then moving device 410 across display 430 to position and orientation 440b. In some implementations, the gesture just described can be a metaphor for the user holding and using the device 410 as a scraper or vacuum to “scrap” or “vacuum” data or files off interface 430 and onto device 410.

Device 410 detects the orientation and motion from location 440a to location 440b, and interprets the orientation and motion as a physical gesture indicating the user's intent to receive data from device 420. For example, the orientation can be detected by monitoring one or more angles between axes fixed to the device and a local level, instantaneous coordinate frame determined by, for example, a gravitational acceleration vector output computed from output of an onboard accelerometer and a vector directed North computed from output of an onboard magnetometer. The presence of device 420 is detected and if communication is not already established, device 410 can establish a wireless communications link 450 with device 420. Upon establishment of link 450, device 410 can request that device 420 transmit any selected data, such as the data corresponding to selected icon 436. The data can be selected by a user of device 420 as described in reference to FIGS. 1A-1C and 2. Device 420 transmits the data over link 450 to device 410. Graphical object 436 can appear on interface 452 of device 410 to visually indicate the receipt of the selected data on device 410. Graphical object 436 can initially be detached from interface 452 until the user of device 410 provides a gesture input or other input means to accept the data. Upon acceptance, graphical object 436 can become fixed to interface 452. Other visual or audio feedback can also be provided to indicate user acceptance of the data.

### Example Network Communication Session

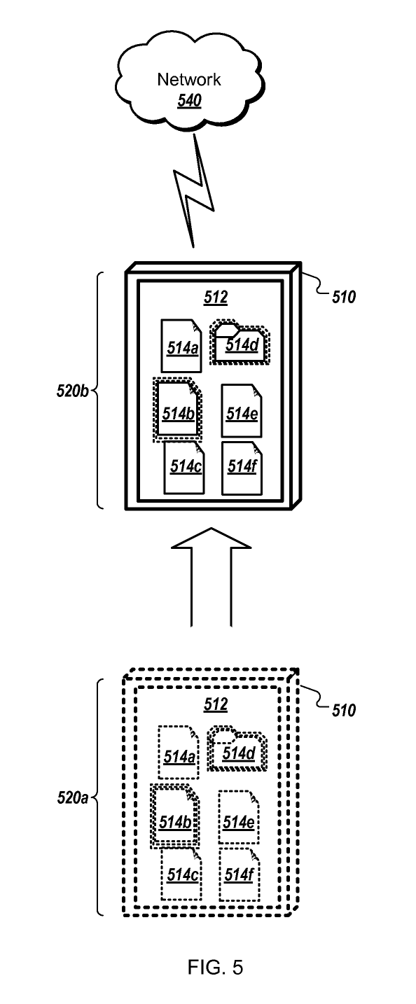

FIG. 5 illustrates an example physical gesture for initiating a communications session with a network. The physical gesture is used to indicate that the user wishes to initiate a communication session with a network resource, such as a network server. For example, the user can lift a handheld device skyward in a gesture that symbolizes uplifting a torch. In response, the device initiates the communication session with the network resource.

The example shown, device 510 includes interface 512 that displays graphical objects 514a-514f (e.g., file icons). Device 510 can be, for example, one of the example devices described above with reference to FIGS. 1A-1C. A user selects one or more objects displayed on device 510, for example, objects 514b and 514d. The user moves device 510 from a first position and orientation 520a to a second position and orientation 520b. Device 510 uses internal position and orientation sensors to detect this motion and determine that the motion is a gesture indicative of an intent to upload data represented by objects 514b and 514d to a remote server (not shown). For example, an onboard accelerometer can monitor for an large acceleration the opposite gravitational acceleration to determine that a gesture was made indicating a request to upload data to a network resource. The user can first put the device in a transfer state using touch or other input so that the acceleration can be interpreted as a gesture and not another source of acceleration, such as an acceleration generated when a user of the device is on an elevator.

Device 510 then establishes wireless communications link 530 to network 540. Wireless communications link 530 can be, for example, a cellular, WiFi, WiMax, satellite, or other wireless communications link to network 540, which can be a cellular telephone data network, a private, commercial, or public WiFi or WiMax access network, a satellite network or other wireless communications network. Once wireless communications link 530 is established, device 510 transmits the data corresponding to selected objects 514a and 514d to the network resource through network 540.

### Other Gestures with Physics Metaphors

In the examples provided above, the user gestures are described in terms of physical gestures and interface gestures. Other implementations of user gestures can be used. For example, a user can initiate transmission of a selected file by generally aligning the device with the target device and then blowing air across the display of the device. One or more microphones on the device can detect the sound of moving air and the direction of airflow. The direction of airflow can be used to infer the intent of the user to identify a target device.

In some implementations, a sending device can be held over a receiving device as shown in FIG. 1C, and a touch sensitive surface (e.g., interface 112) on the sending device can be tapped to cause items to be transferred to the receiving device over a wireless communication link. In this example implementation, each tap can cause one item to transfer. This gesture can be analogized to tapping a Ketchup™ bottle to get the Ketchup™ to flow.

### Example Processes for Intuitive, Gesture-Based User Interfaces

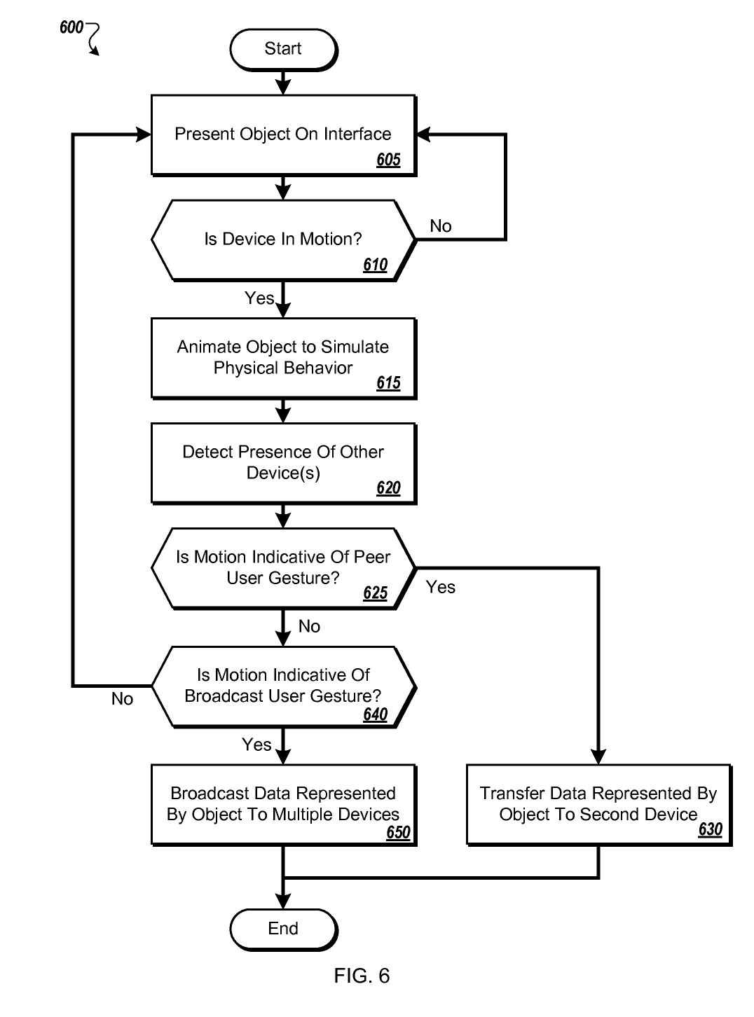

FIG. 6 is a flow diagram of an example process for using intuitive, physical gestures to initiate a communications session between devices. Process 600 can be performed by one or more devices, for example, one or more of the devices described above with reference to FIGS. 1-5. Therefore, for convenience, process 600 is described with reference to a device that performs process 600.

The device presents an object on an interface of the device (605). The object can be, for example, an icon or other representation of content. The interface can be a touch sensitive surface that is responsive to gesture inputs. The device then determines whether the device is in motion (610). Examples of device motion can include changes in device position or orientation, such as tilting, shaking, rotating, spinning, shifting, or combinations of these or other motions. If the device is not in motion, then the device continues to present the object on the interface. If the device is in motion, then the device animates the object to simulate real-world physical behavior (615). For example, the device can animate a graphical representation of the content object (e.g., icon) to make the object appear to slide, ricochet, vibrate, bounce, or perform other reactions to forces based on Newtonian mechanics corresponding to the detected motion.

The device detects one or more other devices (620). The detection can be accomplished using short-range communication technology such as Bluetooth scanning. The device then determines whether the motion is indicative of a peer user gesture (625), A “peer user” gesture is a gesture that suggests a user's intent to transfer data from a first device to a second device (one to one). The data can be stored by the device or accessible by the device (e.g., stored on another device in communication with the device) If so, the device transmits data represented by the object to a second device (630).

If the device determines that the detected motion is not indicative of a peer user gesture, then the device can determine whether the motion is indicative of a broadcast user gesture (640). A “broadcast user gesture” is a gesture that suggests a user's intent to cause a device to transfer data to multiple recipient devices simultaneously (one to many). If so, the device broadcasts the data represented by the object to the multiple recipient devices. If not, the device continues to present the object on the user interface 605.

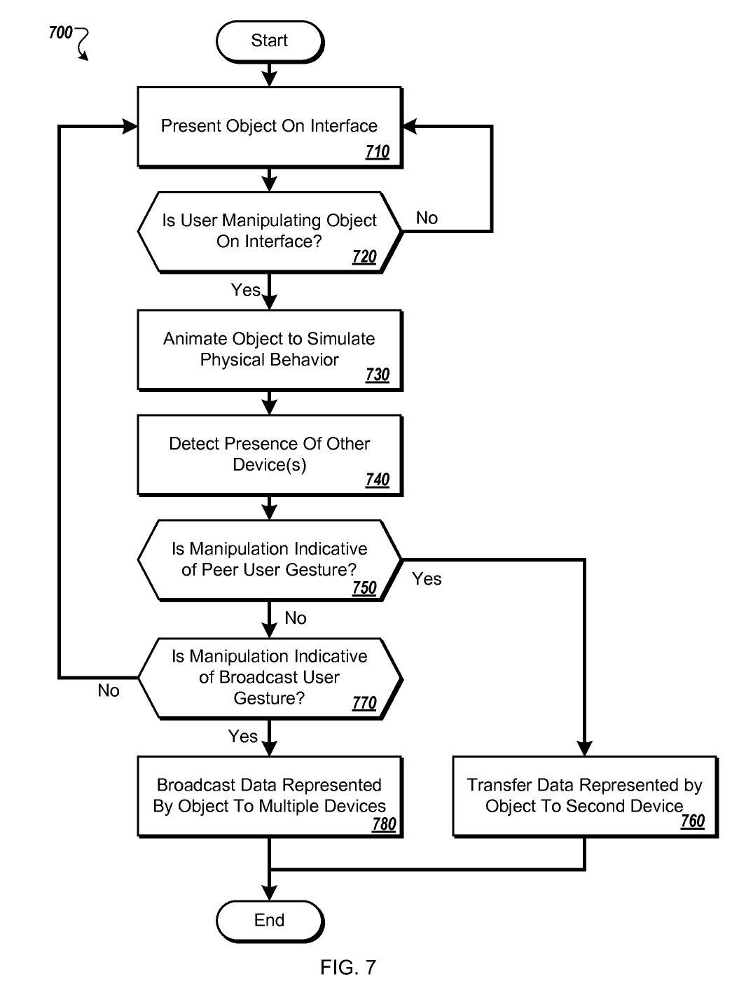

FIG. 7 is a flow diagram of an example process for using intuitive, interface gestures to initiate a communications session between devices. Process 700 can be performed by one or more devices, for example, one or more of the devices described above with reference to FIGS. 1-5. Therefore, for convenience, process 700 is described with reference to a device that performs the process

The device presents 710 an object on the device's interface (710). The device determines whether a user is manipulating the object on the interface (720), for example, using one or more interface gestures such as tapping, clicking, dragging, flicking, pinching, stretching, encircling, rubber banding, or other actions that can be performed to manipulate objects such as icons displayed on a user interface. If the user is not manipulating the content object on the user interface, then the device continues to present the object.

If the user is manipulating the object, then the device animates the object to simulate real-world physical behavior (730). For example, as the user drags the content object, a simulated momentum can be imparted upon the object, such that the object will initially appear to resist the motion in accordance with Newtonian mechanics. Similarly, the object can continue moving after it has been released according to Newtonian mechanics. The device can also simulate the effects of friction upon the motion of the object, e.g., to dampen and eventually halt the object's movement. In some implementations, the object can be animated according to a simulated mass that can be dependent upon the size of the data represented by the content object. For example, the icon of a large data file can be animated to respond more slowly to user manipulation and changes in its simulated momentum to simulate heaviness.

The device then detects the presence of other devices (740). In some implementations, properties of the user's manipulation can be combined with information about the device's position and orientation to determine the intent of the user's manipulation of the object. For example, the direction in which the object is swiped or flicked across an interface by the user's finger can be combined with the device's detected orientation to determine the target device for receiving data from several possible other target devices detected by the device in step 740.

The device then determines whether the user's manipulation of the object is indicative of a peer user gesture (750). If so, the device transmits data represented by the object to the second device (760). Otherwise, if the device determines whether the manipulation is indicative of a broadcast user gesture (770), the device broadcasts data represented by the object so that it can be received by the multiple other devices (780). Otherwise, the device continues to present the object on the user interface (710).

### Example Network Operating Environment

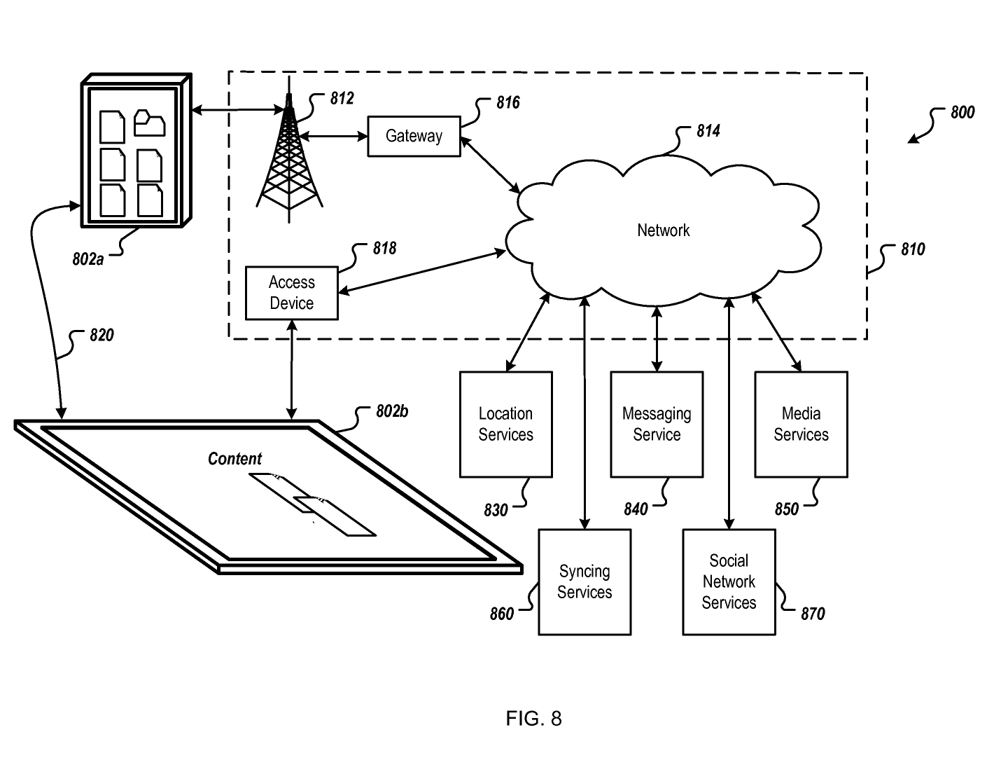

FIG. 8 is a block diagram of example network operating environment for a device for implementing the features and operations described in reference to FIGS. 1-7. Devices 802a and 802b can communicate over one or more wired or wireless networks 810 in data communication. For example, wireless network 812, e.g., a cellular network, can communicate with a wide area network (WAN) 814, such as the Internet, by use of gateway 816. Likewise, access device 818, such as an 802.11 g wireless access device, can provide communication access to wide area network 814. In some implementations, both voice and data communications can be established over wireless network 812 and access device 818. For example, device 802a can place and receive phone calls (e.g., using VoIP protocols), send and receive e-mail messages (e.g., using POP3 protocol), and retrieve electronic documents and/or streams, such as web pages, photographs, and videos, over wireless network 812, gateway 816, and wide area network 814 (e.g., using TCP/IP or UDP protocols). Likewise, in some implementations, device 802b can place and receive phone calls, send and receive e-mail messages, and retrieve electronic documents over access device 818 and wide area network 814. In some implementations, devices 802a or 802b can be physically connected to access device 818 using one or more cables and access device 818 can be a personal computer. In this configuration, device 802a or 802b can be referred to as a “tethered” device.

Devices 802a and 802b can also establish communications by other means. For example, wireless device 802a can communicate with other wireless devices, e.g., other devices 802a or 802b, cell phones, etc., over wireless network 812. Likewise, devices 802a and 802b can establish peer-to-peer communications 820, e.g., a personal area network, by use of one or more communication subsystems, such as a Bluetooth™ communication device. Other communication protocols and topologies can also be implemented.

Devices 802a or 802b can communicate with one or more services over one or more wired and/or wireless networks 810. These services can include, for example, location services 830, input processing service 840, and animation engine 850. Location services 830 can provide location-based services to devices 802a and 802b. Messaging services can provide email, text message and other communication services. Media services 850 can provide online stores for downloading content to devices 802a, 802b, such as music and electronic books. Syncing services 860 can provide network based syncing services for syncing content stored on user devices. Social networking service 870 can provide online communities where users can share content.

Device 802a or 802b can also access other data and content over one or more wired and/or wireless networks 810. For example, content publishers, such as news sites, RSS feeds, web sites, blogs, social networking sites, developer networks, etc., can be accessed by device 802a or 802b. Such access can be provided by invocation of a web browsing function or application (e.g., a browser) in response to a user touching, for example, a Web object.

### Exemplary Mobile Device Architecture

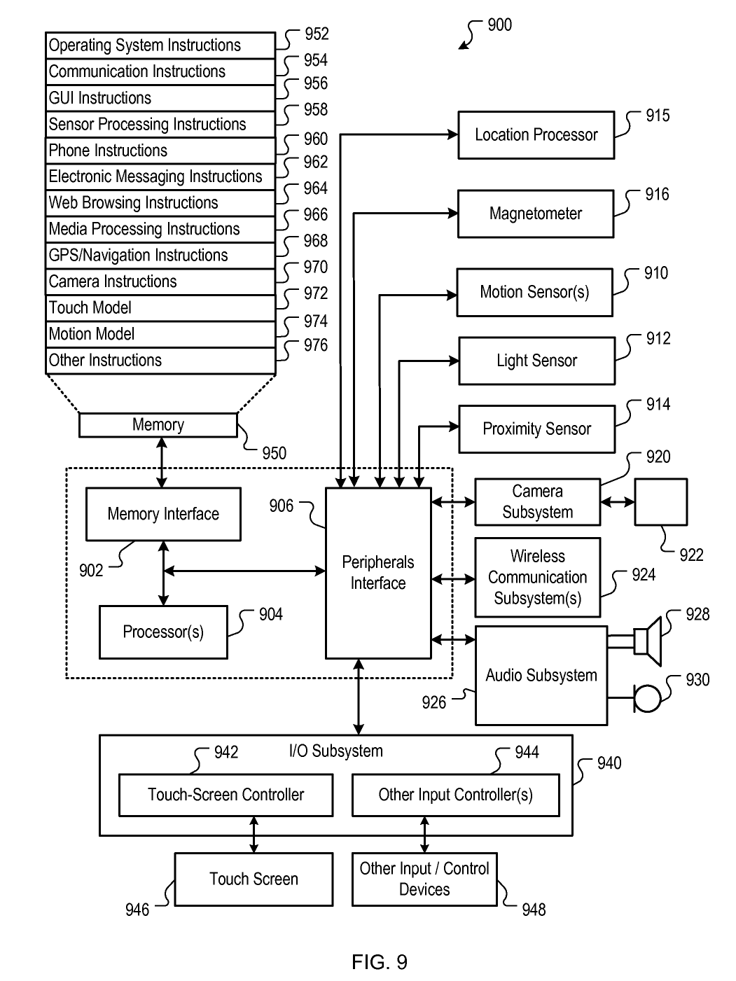

FIG. 9 is a block diagram illustrating an exemplary device architecture of a device implementing the features and operations described in reference to FIGS. 1-8. Device 900 can include memory interface 902, one or more data processors, image processors or central processing units 904, and peripherals interface 906. Memory interface 902, one or more processors 904 or peripherals interface 906 can be separate components or can be integrated in one or more integrated circuits. The various components can be coupled by one or more communication buses or signal lines.

Sensors, devices, and subsystems can be coupled to peripherals interface 906 to facilitate multiple functionalities. For example, motion sensor 910, light sensor 912, and proximity sensor 914 can be coupled to peripherals interface 906 to facilitate orientation, lighting, and proximity functions of the mobile device. For example, in some implementations, light sensor 912 can be utilized to facilitate adjusting the brightness of touch screen 946. In some implementations, motion sensor 910 (e.g., an accelerometer, gyros) can be utilized to detect movement and orientation of the device 900. Accordingly, display objects or media can be presented according to a detected orientation, e.g., portrait or landscape.

Other sensors can also be connected to peripherals interface 906, such as a temperature sensor, a biometric sensor, or other sensing device, to facilitate related functionalities.

Location processor 915 (e.g., GPS receiver) can be connected to peripherals interface 906 to provide geopositioning. Electronic magnetometer 916 (e.g., an integrated circuit chip) can also be connected to peripherals interface 906 to provide data that can be used to determine the direction of magnetic North. Thus, electronic magnetometer 916 can be used as an electronic compass.

Camera subsystem 920 and an optical sensor 922, e.g., a charged coupled device (CCD) or a complementary metal-oxide semiconductor (CMOS) optical sensor, can be utilized to facilitate camera functions, such as recording photographs and video clips.

Communication functions can be facilitated through one or more communication subsystems 924. Communication subsystem(s) 924 can include one or more wireless communication subsystems 924. Wireless communication subsystems can include radio frequency receivers and transmitters and/or optical (e.g., infrared) receivers and transmitters. Wired communication system can include a port device, e.g., a Universal Serial Bus (USB) port or some other wired port connection that can be used to establish a wired connection to other computing devices, such as other communication devices, network access devices, a personal computer, a printer, a display screen, or other processing devices capable of receiving or transmitting data. The specific design and implementation of the communication subsystem 924 can depend on the communication network(s) or medium(s) over which device 900 is intended to operate. For example, a mobile device can include communication subsystems 924 designed to operate over a GSM network, a GPRS network, an EDGE network, a WiFi or WiMax network, and a Bluetooth network. In particular, the wireless communication subsystems 924 can include For example, device 900 may include wireless communication subsystems designed to operate over a global system for mobile communications (GSM) network, a GPRS network, an enhanced data GSM environment (EDGE) network, 802.x communication networks (e.g., WiFi, WiMax, or 3G networks), code division multiple access (CDMA) networks, and a Bluetooth™ network. Communication subsystems 924 may include hosting protocols such that the mobile device 900 may be configured as a base station for other wireless devices. As another example, the communication subsystems can allow the device to synchronize with a host device using one or more protocols, such as, for example, the TCP/IP protocol, HTTP protocol, UDP protocol, and any other known protocol.

Audio subsystem 926 can be coupled to a speaker 928 and one or more microphones 930 to facilitate voice-enabled functions, such as voice recognition, voice replication, digital recording, and telephony functions.

I/O subsystem 940 can include touch screen controller 942 and/or other input controller(s) 944. Touch-screen controller 942 can be coupled to a touch screen 946 or pad. Touch screen 946 and touch screen controller 942 can, for example, detect contact and movement or break thereof using any of a number of touch sensitivity technologies, including but not limited to capacitive, resistive, infrared, and surface acoustic wave technologies, as well as other proximity sensor arrays or other elements for determining one or more points of contact with touch screen 946.

Other input controller(s) 944 can be coupled to other input/control devices 948, such as one or more buttons, rocker switches, thumb-wheel, infrared port, USB port, and/or a pointer device such as a stylus. The one or more buttons (not shown) can include an up/down button for volume control of speaker 928 and/or microphone 930.

In one implementation, a pressing of the button for a first duration may disengage a lock of the touch screen 946; and a pressing of the button for a second duration that is longer than the first duration may turn power to mobile device 400 on or off. The user may be able to customize a functionality of one or more of the buttons. The touch screen 946 can also be used to implement virtual or soft buttons and/or a keyboard.

In some implementations, device 110 can present recorded audio and/or video files, such as MP3, AAC, and MPEG files. In some implementations, mobile device 110 can include the functionality of an MP3 player, such as an iPod™. Mobile device 110 may, therefore, include a pin connector that is compatible with the iPod. Other input/output and control devices can be used.

Memory interface 902 can be coupled to memory 950. Memory 950 can include high-speed random access memory or non-volatile memory, such as one or more magnetic disk storage devices, one or more optical storage devices, or flash memory (e.g., NAND, NOR). Memory 950 can store operating system 952, such as Darwin, RTXC, LINUX, UNIX, OS X, WINDOWS, or an embedded operating system such as VxWorks. Operating system 952 may include instructions for handling basic system services and for performing hardware dependent tasks. In some implementations, operating system 952 can include a kernel (e.g., UNIX kernel).

Memory 950 may also store communication instructions 954 to facilitate communicating with one or more additional devices, one or more computers and/or one or more servers. Communication instructions 954 can also be used to select an operational mode or communication medium for use by the device, based on a geographic location (obtained by the GPS/Navigation instructions 968) of the device. Memory 950 may include graphical user interface instructions 956 to facilitate graphic user interface processing; sensor processing instructions 958 to facilitate sensor-related processing and functions; phone instructions 960 to facilitate phone-related processes and functions; electronic messaging instructions 962 to facilitate electronic-messaging related processes and functions; web browsing instructions 964 to facilitate web browsing-related processes and functions; media processing instructions 966 to facilitate media processing-related processes and functions; GPS/Navigation instructions 968 to facilitate GPS and navigation-related processes and instructions; camera instructions 970 to facilitate camera-related processes and functions; touch model 972 for interpreting touch and gesture input from raw touch input data to facilitate the processes and features described with reference to FIGS. 1-8; and a motion model 974 to interpret device motions from raw motion sensor data to facilitate the processes and features of FIGS. 1-7. The memory 950 may also store other software instructions 976 for facilitating other processes, features and applications.

Each of the above identified instructions and applications can correspond to a set of instructions for performing one or more functions described above. These instructions need not be implemented as separate software programs, procedures, or modules. Memory 950 can include additional instructions or fewer instructions. Furthermore, various functions of the mobile device may be implemented in hardware and/or in software, including in one or more signal processing and/or application specific integrated circuits.

The features described can be implemented in digital electronic circuitry, in computer hardware, firmware, software, or in combinations of them. The features can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. Alternatively or in addition, the program instructions can be encoded on a propagated signal that is an artificially generated signal, e.g., a machine-generated electrical, optical, or electromagnetic signal that is generated to encode information for transmission to suitable receiver apparatus for execution by a programmable processor.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network. The relationship of client and server arises by virtue of computer programs running on the respective computers and having a client-server relationship to each other.

One or more features or steps of the disclosed embodiments can be implemented using an Application Programming Interface (API). An API can define on or more parameters that are passed between a calling application and other software code (e.g., an operating system, library routine, function) that provides a service, that provides data, or that performs an operation or a computation.

The API can be implemented as one or more calls in program code that send or receive one or more parameters through a parameter list or other structure based on a call convention defined in an API specification document. A parameter can be a constant, a key, a data structure, an object, an object class, a variable, a data type, a pointer, an array, a list, or another call. API calls and parameters can be implemented in any programming language. The programming language can define the vocabulary and calling convention that a programmer will employ to access functions supporting the API.

In some implementations, an API call can report to an application the capabilities of a device running the application, such as input capability, output capability, processing capability, power capability, communications capability, etc.

A number of implementations have been described. Nevertheless, it will be understood that various modifications may be made. For example, elements of one or more implementations may be combined, deleted, modified, or supplemented to form further implementations. Yet in another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A computer-implemented method, comprising:
presenting an object on an interface of a first device, the object representing data stored or accessible by the first device;
detecting motion based on data from sensors onboard the first device;
receiving input selecting the object;
responsive to the input and the detected motion, animating the object on the interface using a physics metaphor, where the animation dynamically changes in response to the detected motion;
detecting a presence of a second device located in proximity to the first device;
determining that the detected motion results from a physical gesture made by a user of the first device, the physical gesture indicating a request to transfer the data to the second device; and
responsive to the determining and to the detected presence of the second device, initiating data transfer to the second device.

2. The method of claim 1, where presenting an object on an interface, further comprises:
presenting an object on a touch sensitive surface.

3. The method of claim 2, where receiving user input further comprises:
receiving touch input selecting the object through the touch sensitive surface;
determining that the touch input has exceeded a predetermined time or pressure; and
animating the object using the physics metaphor so that the object appears to be detached from the interface and freely moving on the interface in response to motion of the device.

4. The method of claim 3, where the first or second device is an electronic tablet.

5. The method of claim 1, where animating the object on the interface further comprises:
animating the object during data transfer to the second device, where the animating is based on the size of the data represented by the object.

6. The method of claim 5, where an order or speed of data transfer is based on the location of the animated object in the interface or the size of the data being transferred.

7. A computer-implemented method, comprising:
receiving on a first device a request to receive data from a second device proximate to the first device and in communication with the first device;
detecting receipt of data from the second device;
presenting an object on an interface of the first device, the object representing the data received on the first device; and
animating the object on the interface using a physics metaphor.

8. The method of claim 7, where presenting an object on an interface of the first device, further comprises:
presenting an object on a touch sensitive surface of the first device.

9. The method of claim 8, further comprising:
receiving touch input selecting the object through the touch sensitive surface;
determining that the touch input has exceeded a predetermined time or pressure; and
fixing the object to the interface so that the object cannot move freely in the interface in response to motion of the device.

10. The method of claim 7, where the first or second device is an electronic tablet.

11. The method of claim 7, where animating the object on the interface further comprises:
animating the object during data transfer to the first device, where the animating is based on the size of the data represented by the object.

12. The method of claim 11, where an order or speed of data transfer is based on the location of the animated object in the interface or the size of the data being transferred.

13. A computer-implemented method, comprising:
receiving gesture input selecting an object on a touch sensitive surface of a first device, the object representing data to be transferred to at least one other device;
determining a direction of the gesture on the touch sensitive surface;
receiving position information from one or more devices proximate to the first device;
selecting a target device for receiving data, where the target device is determined based on the position information and the sensor data; and
initiating a transfer of the data to the selected target device.

14. The method of claim 13, where selecting a target device further comprises:
determining line of sight vectors from the position vectors;
transforming the line of sight vectors from an inertial coordinate frame to a display coordinate frame associated with the touch sensitive surface;
defining a gesture vector representing the direction of the gesture in the display coordinate frame;
determining an angular separation between the gesture vector and each line of sight vector in the display coordinate frame; and
selecting a target device having a line of sight vector with the smallest angular separation with the gesture vector in the display coordinates.

15. A computer-implemented method comprising:
receiving physical gesture input indicating an intent to broadcast data stored or accessible by a device;
determining two or more target devices for receiving the data from the device, where the target devices are located proximate to the device and in communication with the device; and
broadcasting the data to the two or more target devices.

16. The method of claim 15, where the physical gesture is a clockwise or counterclockwise rotational or sweeping gesture made in the general direction of the target devices by a hand of a user holding the device.

17. A computer-implemented, comprising:
receiving physical gesture input indicating an intent to send data to, or receive data from a network resource; and
responsive to the physical gesture, sending data to, or receiving data from the network resource.

18. A computer-implemented method, comprising:
receiving input through a first interface of a first device, the input requesting data from a second device located proximate to the first device and in communication with the first device, the second device having a second interface displaying an object representing the data requested by the first device;
detecting an orientation and motion of the first device using sensor data output from at least one motion sensor onboard the first device, where the orientation and motion indicate an a request to transfer the data from the second device to the first device; and
responsive to the detecting, initiating a transfer of the data from the second device to the first device, where the initiating of the data transfer includes animating the object in the second interface using a physics metaphor, where the object appears to be scraped or vacuumed out of the second interface.

19. The method of claim 18, where the first or second device is an electronic tablet.

20. A system comprising:
a motion sensor;
a processor;
a computer-readable medium storing instructions, which, when executed by the processor, causes the processor to perform operations comprising:
presenting an object on an interface of the system, the object representing data stored or accessible by the system;
detecting motion based on data from the motion sensor;
receiving input selecting the object;
responsive to the input and the detected motion, animating the object on the interface using a physics metaphor, where the animation dynamically changes in response to the detected motion;
detecting a presence of a device located in proximity to the system;
determining that the detected motion results from a physical gesture made by a user of the system, the physical gesture indicating a request to transfer the data to the device; and
responsive to the determining and to the detected presence of the device, initiating data transfer to the device.

21. The system of claim 20, where receiving user input further comprises:
receiving touch input selecting the object through the interface;
determining that the touch input has exceeded a predetermined time or pressure; and
animating the object using the physics metaphor so that the object appears to be detached from the interface and freely moving on the interface in response to motion of the system.

22. The system of claim 20, where animating the object on the interface further comprises:
animating the object during data transfer to the device, where the animating is based on the size of the data represented by the object.

23. The system of claim 22, where an order or speed of data transfer is based on the location of the animated object in the interface or the size of the data being transferred.

24. A system comprising:
a processor;
a computer-readable medium storing instructions, which, when executed by the processor, causes the processor to perform operations comprising:
receiving a request to receive data from a device proximate to the system and in communication with the system;
detecting receipt of data from the device;
presenting an object on an interface of the system, the object representing the data received on the device; and
animating the object on the interface using a physics metaphor.

25. The system of claim 24, further comprising:
receiving touch input selecting the object through the interface;
determining that the touch input has exceeded a predetermined time or pressure; and
fixing the object to the interface so that the object cannot move freely in the interface in response to motion of the system.

26. The method of claim 24, where animating the object on the interface further comprises:
animating the object during data transfer to the first device, where the animating is based on the size of the data represented by the object.

27. The system of claim 26, where an order or speed of data transfer is based on the location of the animated object in the interface or the size of the data being transferred.
